(19) United States
(12) Patent Application Publication
(10) Pub. No.: US 2018/0094439 A1
(43) Pub. Date: Apr. 5, 2018

(54) ETHYLENE-BASED THERMOPLASTIC ROOFING MEMBRANES

(71) Applicant: FIRESTONE BUILDING PRODUCTS CO., LLC, Nashville, TN (US)

(72) Inventors: Hao WANG, Carmel, IN (US); Michael J. HUBBARD, Anderson, IN (US)

(73) Assignee: FIRESTONE BUILDING PRODUCTS CO., LLC, Nashville, TN (US)

(21) Appl. No.: 15/548,938

(22) PCT Filed: Feb. 8, 2016
(86) PCT No.: PCT/US2016/016960

§ 371 Date: Aug. 4, 2017

Related U.S. Application Data
(60) Provisional application No. 62/112,921, filed on Feb. 6, 2015.

(51) Int. Cl. E04D 5/06; B32B 27/08; B32B 27/32; E04D 5/10; C08L 23/06; C08K 3/22; C08K 3/34

(52) U.S. Cl. CPC E04D 5/06; B32B 27/08; B32B 27/32; E04D 5/10; C08F 297/08; C08K 3/22; C08K 3/346; B32B 2323/04; B32B 2419/06; C08L 23/06

(57) ABSTRACT

A thermoplastic roofing membrane comprising a planar thermoplastic sheet, optionally having more than one layer, where at least one layer of the membrane includes an ethylene-based olefinic block copolymer.

This application claims the benefit of U.S. Provisional Patent Application Ser. No. 62/112,921, filed on Feb. 6, 2015, which is incorporated herein by reference.

### FIELD OF THE INVENTION

Embodiments of the present invention are directed toward thermoplastic roofing membranes that include one or more layers that include ethylene-based thermoplastic polymers.

### BACKGROUND OF THE INVENTION

Within the building and construction industry, it is common to cover flat or low-sloped roofs with polymeric membranes. Both thermoset and thermoplastic membranes are commonly employed.

The thermoplastic membranes are often prepared from thermoplastic polyolefins (TPOs), which are propylene-based materials that are believed to include ethylene-propylene rubber dispersed therein as a result of the synthesis process. Propylene-based materials are often used since propylene-based materials have a relatively high melt temperature and can therefore withstand temperatures experienced on the surface of a roof. The ability to withstand increased temperatures, however, is just one necessary attribute of a thermoplastic membrane. Thermoplastic membranes must also exhibit useful flexibility and softness, which attributes facilitate installation and provide desirable mechanical properties for conditions experienced on a roof surface. Furthermore, the materials employed in preparing thermoplastic roofing membranes must exhibit certain characteristics, such as melt flow properties, that allow the materials to be extruded using technologically efficient fabrication procedures.

### SUMMARY OF THE INVENTION

One or more embodiments of the present invention provide a thermoplastic roofing membrane comprising a planar thermoplastic sheet, optionally having more than one layer, where at least one layer of the membrane includes an ethylene-based olefinic block copolymer.

Still other embodiments of the present invention provide a mechanically-attached roofing system comprising a roof substrate, a thermoplastic membrane including at least one layer that includes an ethylene-based olefinic block copolymer, and fasteners that fasten the thermoplastic membrane to the roof substrate.

Still other embodiments of the present invention provide a method for forming a mechanically-attached roof system, the method comprising applying a membrane to a roof substrate, wherein the membrane includes a planar sheet of thermoplastic polymer, optionally having more than one layer, where at least one layer of the membrane includes an ethylene-based olefinic block copolymer and at least 10 percent by weight filler, based on the total weight of the at least one layer and mechanically fastening the membrane to the substrate.

### BRIEF DESCRIPTION OF THE DRAWINGS

FIG. 1 is a perspective view of a multi-layered membrane including two coextruded laminated layers according to embodiments of the present invention.

FIG. 2 is a perspective view of a multi-layered membrane including two laminated layers according to embodiments of the present invention.

FIG. 3 is a perspective, cross sectional view of a mechanically-attached roof assembly according to embodiments of the present invention.

### DETAILED DESCRIPTION OF ILLUSTRATIVE EMBODIMENTS

Embodiments of the invention are based, at least in part, on the discovery of a thermoplastic roofing membrane having at least one layer that includes an ethylene-based olefinic block copolymer. In particular embodiments, the one or more layers include a blend of the ethylene-based olefinic block copolymer and a distinct polyolefin. In these or other embodiments, the ethylene-based olefinic block copolymer, which is optionally blended with the distinct polyolefin, is included in at least one layer of a multi-layered membrane including, for example, bilaminate membranes or membranes including two or more co-extruded layers. In one or more embodiments, the membranes in the present invention are advantageously employed to produce roofing systems where the membrane is mechanically attached to the roof substrate and meet industry standards for wind uplift including FM 4470. Accordingly, the membranes of one or more embodiments of the present invention satisfy the requirements of ASTM D6878.

### Membrane Construction

In one or more embodiments, the membranes of the present invention include at least two layers laminated to one another with an optional scrim disposed between the layers. In one or more embodiments, both layers include the ethylene-based olefinic block copolymer according to the present invention. In other embodiments, one layer of a two-layered, laminated membrane includes the ethylene-based olefinic block copolymer according to the present invention. In one or more embodiments, the one layer of the two-layered, laminated membrane that includes the ethylene-based olefinic block copolymer is the lower layer or bottom layer of the membrane, which is the layer that is contacted to the roof substrate; i.e. the side opposite the surface of the membrane that is exposed to the environment. In yet other embodiments, the one layer of the two-layered, laminated membrane that includes the ethylene-based olefinic block copolymer is the upper layer or top layer of the membrane, which the layer that is exposed to the environment and therefore opposite the lower or bottom layer.

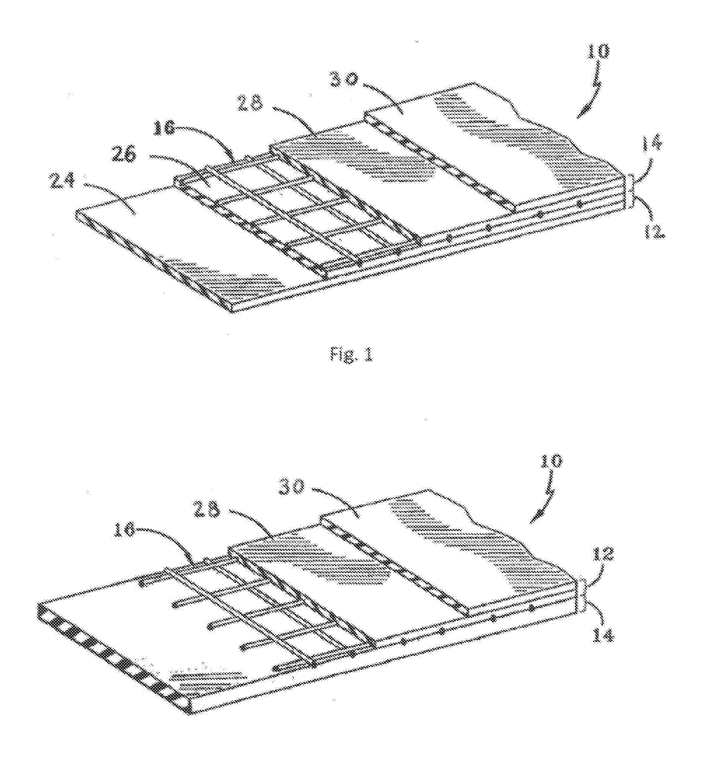

An example of a two-layered, laminated membrane is shown in FIGS. 1 and 2, which show membrane 10 having first or lower layer 12, a second or upper layer 14, and optional scrim 16 disposed there between. In one or more embodiments, lower layer 12 may include ethylene-based olefinic block copolymer. In these or other embodiments, upper layer 14 may include ethylene-based olefinic block copolymer. In one or more embodiments, one of lower layer 12 and upper layer 14 may be devoid or substantially devoid of ethylene-based olefinic block copolymer. Reference to substantially devoid includes that amount or less of a particular constituent (e.g. ethylene-based olefinic block copolymer) that does not have an appreciable impact on the layer or membrane.

In one or more embodiments, the membranes of the present invention are multi-layered membranes that include one or more coextruded layers. In this respect, U.S. Publ. Nos. 2009/0137168, 2009/0181216, 2009/0269565, 2007/0193167, and 2007/0194482 are incorporated herein by reference. In one or more embodiments, at least one of the coextruded layers includes an ethylene-based olefinic block copolymer according to one or more aspects of the present invention. For example, and with reference to FIG. 1, lower or bottom layer 12 includes coextruded layers 24 and 26, and upper layer 14 optionally includes coextruded layers 28 and 30. Lower layer 12 and upper layer 14 may be laminated to each other with optional scrim 16 disposed there between. In one or more embodiments, coextruded layer 24, which may be referred to as bottom coextruded layer 24, includes the ethylene-based olefinic block copolymer according the present invention. In these or other embodiments, coextruded layer 26, which may be referred to as lower-middle coextruded layer 26, includes the ethylene-based olefinic block copolymer. In certain embodiments, both coextruded layer 24 and coextruded layer 26, include the ethylene-based olefinic block copolymer according the present invention. In certain embodiments, layers 24 and 26 are compositionally the same, and both layers 24 and 26 include the ethylene-based olefinic block copolymer. This embodiment is shown in FIG. 2.

In still other embodiments, coextruded layer 30, which may be referred to as top coextruded layer 30, includes the ethylene-based olefinic block copolymer according the present invention. In these or other embodiments, coextruded layer 28, which may be referred to as upper-middle coextruded layer 28, includes the ethylene-based olefinic block copolymer according the present invention. In certain embodiments, both coextruded layer 28 and coextruded layer 30, include the ethylene-based olefinic block copolymer according the present invention.

In yet other embodiments, both coextruded layers 26 and 28 (i.e. lower-middle layer 26 and upper-middle layer 28) include the ethylene-based olefinic block copolymer according the present invention. In certain embodiments, coextruded layers 26 and 28 (i.e. lower-middle layer 26 and upper-middle layer 28), as well as bottom coextruded layer 24, include the ethylene-based olefinic block copolymer according the present invention.

In one or more embodiments, the thickness of coextruded layers 24 and 26 may be the same or substantially similar. In other embodiments, the thickness of coextruded bottom layer 24 may be thinner than coextruded upper layer 24.

In one or more embodiments, the remaining layers of the multi-layered membrane may include the ethylene-based olefinic block copolymer. In other embodiments, the remaining layers of the multi-layered membrane may be devoid of ethylene-based olefinic block copolymer. For example, the coextruded upper layer 30 may be devoid of the ethylene-based olefinic block copolymer. Also, the one or more optional coextruded layers of the upper ply (e.g. coextruded layer 28 of ply 14) may be devoid of the ethylene-based olefinic block copolymer.

Still further, an exemplary embodiment can be described with reference to FIG. 1 where upper middle layer 28, as well as lower middle layer 26 and bottom layer 24 include ethylene-based olefinic block copolymer. In these or other embodiments, top layer 30 may also include ethylene-based olefinic block copolymer. In certain embodiments, top layer 30 includes a propylene-based olefinic polymer such as thermoplastic polyolefin or a propylene-based elastomer. Additionally, in certain embodiments, bottom layer 24 includes a functionalized thermoplastic resin. In one or more embodiments, top layer 30 includes flame retardants and other weathering additives that provide sufficient environmental protection to the polymers, while at least one of layers 24, 26, and 28 may include fillers such as mineral fillers.

In one or more embodiments, the overall thickness of the membranes of the present invention may be from about 20 mils up to about 100 mils, and in certain embodiments from about 30 mils to about 80 mils. The layers (e.g., layers 12 and 14) may each account for about half of the overall thickness (e.g., 10 mils to about 40 mils), with a small fraction of the overall thickness (e.g., about 5 mils) deriving from the presence of the scrim. Where the membrane includes one or more coextruded layers, the bottom layer 24 may, in certain embodiments, have a thickness from about 2 mils to about 20 mils, or in other embodiments from about 4 mils to about 12 mils.

In one or more embodiments, the membranes of the present invention may also be constructed by laminating a thin sheet of polymer having dispersed therein the ethylene-based olefinic block copolymer to one or more sheets of thermoplastic membrane. For example, a thin film of polymer having the ethylene-based olefinic block copolymer dispersed therein may be laminated to a conventional thermoplastic membrane or to a component (i.e., the lower layer) of a conventional thermoplastic membrane. The thin sheet having the ethylene-based olefinic block copolymer dispersed therein may have a thickness of about 2 mils to about 20 mils, or in other embodiments from about 4 mils to about 12 mils.

In one or more embodiments, the scrim may include conventional scrim. For example, polyester scrims may be employed. In these or other embodiments, polyester scrims including fiberglass reinforcement may be employed.

### Constituents of the Membrane

### Thermoplastic Component

In one or more embodiments, regardless of the number of layers or coextrudates of the membranes, each layer or coextrudate includes a thermoplastic polymer (excluding any scrim reinforcement). Any other ingredients or constituents of each layer is dispersed within the thermoplastic polymer, and therefore reference may be made to a thermoplastic component that forms a matrix in which the other constituents are dispersed.

As the skilled person appreciates, one or more layers of the thermoplastic membranes of the present invention compositionally includes a thermoplastic component that forms a continuous phase (i.e., matrix) in which one or more additional materials may be dispersed. Where the thermoplastic component includes one or more portions (e.g., blocks) that phase separate, the thermoplastic matrix may include phase-separated regions or domains.

As indicated above, one or more layers of the membranes of the present invention may include an ethylene-based olefinic block copolymer. In one or more embodiments, the ethylene-based olefinic block copolymer may form the entire matrix of the one or more layers. In other embodiments, the ethylene-based olefinic block copolymer is present together with one or more additional, yet distinct, thermoplastic polymers to form the matrix of the one or more layers. These additional thermoplastic polymers may be referred to as distinct polyolefins or complementary polyolefins.

In one or more embodiments, the distinct thermoplastic polymer that may be employed in conjunction with the ethylene-based olefinic block copolymer is a linear low-density polyethylene.

As suggested above, at least one layer of the thermoplastic membranes of this invention include the ethylene-based olefinic block copolymer, optionally together with a distinct polyolefin such as linear low-density polyethylene. Where the membrane includes additional layers that are devoid or substantially devoid of the ethylene-based olefinic block copolymer, these additional layers may include thermoplastic polymers conventionally employed in the preparation of thermoplastic membranes. For example, these additional layers may include polypropylene-based thermoplastic polymers such as propylene-based thermoplastic polyolefins or propylene-based elastomers.

Regardless of the thermoplastic material employed in any given layer, the one or more layers of the membranes of this invention may include additional constituents such as fillers, flame retardants, stabilizers, and the like. In particular embodiments, the one or more layers including the ethylene-based olefinic block copolymer may include mineral filler. In fact, in one or more embodiments, the mineral filler loading is relatively high and yet the membrane maintains sufficient properties to be useful in creating mechanically attached roofing systems that meet industry standards for wind uplift including FM 4470 and satisfy the requirements of ASTM D6878.

### Ethylene-Based Olefinic Block Copolymer

In general, the ethylene-based olefinic block copolymers include block copolymers including a first plurality of ethylene-α-olefin blocks having low α-olefin content and a second plurality of ethylene-α-olefin blocks having a high α-olefin content. For purposes of this specification, the α-olefin may be referred to as a comonomer. Also, for purposes of this specification, the first plurality may be referred to as the hard blocks since these blocks are characterized by a relatively high melt temperature, and the second plurality of blocks may be referred to as the soft blocks since these block are characterized by a low glass transition temperature. In one or more embodiments, the hard blocks are crystallizable and the soft blocks are amorphous. In one or more embodiments, the α-olefin includes C₄ or higher α-olefins. In particular embodiments, the α-olefin is selected from butane, hexene, and octene. In particular embodiments, the α-olefin is octene.

In one or more embodiments, the ethylene-based olefinic block copolymer includes hard and soft blocks alternating in (AB)ₙ pattern where A is a hard block, B is a soft block, and ₙ is an integer greater than 1 including 2, 3, 4, 5, 10, 20, 40, 60, 80, 100, or higher.

As suggested above, the hard blocks, which may also be referred to as hard segments, have a relatively low comonomer content (i.e., α-olefin). In one or more embodiments, the comonomer content (i.e, comonomer in polymerized form) of the hard block is less than 5 wt. %, in other embodiments less than 2 wt. %, and in other embodiments less than 1 wt. %, with the balance of the polymeric units deriving from ethylene. Accordingly, the hard segments may include greater than 95 wt. %, in other embodiments greater than 98 wt. %, and in other embodiments greater than 99 wt. % polymeric units deriving from ethylene. In particular embodiments, the hard segments exclusively include or substantially include ethylene-derived units.

The soft block, which may also be referred to as soft segments, have a relatively high comonomer content (i.e., α-olefin). In one or more embodiments, the comonomer content (i.e., comonomer in polymerized form) of the soft block is greater than 5 wt. %, in other embodiments greater than 8 wt. %, in other embodiments greater than 10 wt. %, in other embodiments greater than 15 wt. %, in other embodiments greater than 25 wt. %, in other embodiments greater than 35 wt. %, in other embodiments greater than 45 wt. %, and in other embodiments greater than 60 wt. %, with the balance including ethylene-derived units.

In one or more embodiments, the ethylene-based olefinic block copolymers employed in the present invention are characterized by a weight average molecular weight (Mw) of from about 10 to 2,500 kg/mol, in other embodiments from about 20 to about 500 kg/mol, and in other embodiments from about 30 to about 350 kg/mol. In these or other embodiments, the ethylene-based olefinic block copolymers are characterized by a polydispersity of less than 3.5, in other embodiments less than 3.0, and in other embodiments less than 2.0. In these or other embodiments, the ethylene-based olefinic block copolymers employed in the present invention are characterized by a Mooney viscosity (ML₁₊₄@125° C.) of from about 1 to about 250.

In one or more embodiments, the ethylene-based olefinic block copolymers employed in the present invention are characterized by a density of less than 0.9 g/cm³, in other embodiments less than 0.89 g/cm³, in other embodiments less than 0.885 g/cm³, and in other embodiments less than 0.875 g/cm³. In these or other embodiments, the density of the ethylene-based olefinic block copolymers is greater than 0.85 g/cm³ and in other embodiments greater than 0.86 g/cm³. As the skilled person appreciates, density can be determined according to ASTM D-792.

In one or more embodiments, the ethylene-based olefinic block copolymers employed in the present invention are characterized by a melt temperature, as measured by differential scanning calorimetry as described in U.S. Publ No. 2006/0199930, of at least 105, in other embodiments at least 110, in other embodiments at least 115, and in other embodiments at least 120° C. In these or other embodiments, the ethylene-based olefinic block copolymers are characterized by a melt temperature of less than 130 and in other embodiments less than 125° C.

In one or more embodiments, the first EBOC, which is characterized by a relatively low melt index, may have a melt index, as determined by ASTM D1238 or ISO 1133 (2.16 kg load at 190° C.), of less than 5 g/10 min, in other embodiments less than 2 g/10 min, and in other embodiments less than 1 g/10 min. In these or other embodiments, the melt index of the first EBOC is from about 0.1 to about 5 g/10 min, in other embodiments from about 0.3 to about 2 g/10 min, and in other embodiments from about 0.5 to about 1 g/10 min.

In one or more embodiments, the second EBOC, which is characterized by a relatively high melt index, as determined by ASTM D1238 or ISO 1133 (2.16 kg load at 190° C.), may have a melt index of greater than 5 g/10 min, in other embodiments greater than 15 g/10 min, and in other embodiments greater than 25 g/10 min. In these or other embodiments, the melt index of the second EBOC is from about 5 to about 50 g/10 min, in other embodiments from about 15 to about 40 g/10 min, and in other embodiments from about 25 to about 35 g/10 min.

In one or more embodiments, the ethylene-based olefinic block copolymers employed in the present invention are characterized by a glass transition temperature, as measured by differential scanning calorimetry, of at less than 0° C., in other embodiments less than −20° C., in other embodiments less than −30° C., and in other embodiments less than −40° C. In these or other embodiments, the ethylene-based olefinic block copolymers are characterized by a glass transition temperature of from about −50° C. to about 0° C.

Useful ethylene-based olefinic block copolymers that may be employed in the present invention are known in the art as described in U.S. Pat. Nos. 7,893,166 and 7,355,089 and U.S. Publ. No. 2010/0084158, which are incorporated herein by reference. Useful ethylene-based olefinic block copolymers are commercially available under the tradename INFUSE (Dow Chemical Company) including those specific polymers available under the tradenames 9010 and 9900.

### Distinct Thermoplastic Resins

As suggested above, the one or more layers of the thermoplastic membranes of the present invention that include the ethylene-based olefinic block copolymer may also include a distinct thermoplastic resin, which is a thermoplastic resin other than the ethylene-based olefinic block copolymer. Also, the other optional layers of the thermoplastic membranes of this invention that may not include ethylene-based olefinic block copolymer may include one or more non-ethylene-based olefinic block copolymers. In one or more embodiments, the non-ethylene-based olefinic block copolymers (i.e., distinct thermoplastic resins) may include thermoplastic polyolefins of the type conventionally employed in the manufacture of thermoplastic membranes. In these or other embodiments, the non-ethylene-based olefinic block copolymers may include low density polyethylene. In yet other embodiments, the non-ethylene-based olefinic block copolymers may include propylene-based elastomers.

### Thermoplastic Polyolefins (TPOS)

In one or more embodiments, the thermoplastic olefinic polymer (TPO) employed in one or more embodiments of this invention may include an olefinic reactor copolymer, which may also be referred to as in-reactor copolymer. Reactor copolymers are generally known in the art and may include blends of olefinic polymers that result from the polymerization of ethylene and α-olefins (e.g., propylene) with sundry catalyst systems. In one or more embodiments, these blends are made by in-reactor sequential polymerization. Reactor copolymers useful in one or more embodiments include those disclosed in U.S. Pat. No. 6,451,897, which is incorporated therein by reference. Reactor copolymers, which are also referred to as TPO resins, are commercially available under the tradename HIFAX™ (Lyondellbassel); these materials are believed to include in-reactor blends of ethylene-propylene rubber and polypropylene or polypropylene copolymers. Other useful thermoplastic olefins include those available under the tradename T00G-00 (Ineos). In one or more embodiments, the in-reactor copolymers may be physically blended with other polyolefins. For example, in reactor copolymers may be blended with linear low density polyethylene.

In other embodiments, the thermoplastic component may include a physical blend of chemically-distinct olefinic polymers. In one or more embodiments, blends of propylene-based thermoplastic polymer, plastomer, and/or low density polyethylene may be used. Useful blends include those described in International Application No. PCT/US06/033522 which is incorporated herein by reference. In other embodiments, the thermoplastic olefinic component is a blend of a linear low density polyethylene and a propylene-based plastic.

### Low-Density Polyethylene

In one or more embodiments, the low density polyethylene includes an ethylene-α-olefin copolymer. In one or more embodiments, the low density polyethylene includes linear low density polyethylene. The linear low density polyethylene employed in one or more embodiments of this invention may be similar to that described in U.S. Pat. No. 5,266,392, which is incorporated herein by reference. This copolymer may include from about 2.5 to about 13 mole percent, and in other embodiments from about 3.5 to about 10 mole percent, mer units deriving from α-olefins, with the balance including mer units deriving from ethylene. The α-olefin included in the linear low density polyethylene of one or more embodiments of this invention may include butene-1, pentene-1, hexene-1, octene-1, or 4-methyl-pentene-1. In one or more embodiments, the linear low density polyethylene is devoid or substantially devoid of propylene mer units (i.e., units deriving from propylene). Substantially devoid refers to that amount or less of propylene mer units that would otherwise have an appreciable impact on the copolymer or the compositions of this invention if present.

The linear low density polyethylene employed in one or more embodiments of this invention can be characterized by a density of from about 0.885 g/cc to about 0.930 g/cc, in other embodiments from about 0.900 g/cc to about 0.920 g/cc, and in other embodiments from about 0.900 g/cc to about 0.910 g/cc per ASTM D-792.

In one or more embodiments, the linear low density polyethylene may be characterized by a melt index of from about 0.2 to about 50 dg/min, in other embodiments from about 0.4 to about 20 dg/min, and in other embodiments from about 0.6 to about 10 dg/min per ASTM D1238 or ISO 1133 at 190° C. and 2.16 kg load.

The linear low density polyethylene of one or more embodiments of this invention may be prepared by using a convention Ziegler Natta coordination catalyst system.

Useful linear low density polyethylene includes those that are commercially available. For example, linear low density polyethylene can be obtained under the tradename Dowlex™ 2038, 2045, and 2267G (Dow); under the tradename DFDA-1010NT7 (Dow); or under the tradename GA502023 (Lyondell); or under the tradename LLDPE LL (ExxonMobil).

### Propylene-Based Elastomers

In one or more embodiments, useful propylene-based elastomers include propylene-based elastomers that have isotactic propylene sequences long enough to crystallize. In this regard, U.S. Pat. No. 6,927,258, and U.S. Publ. Nos. 2004/0198912 and 2010/0197844 are incorporated herein by reference. In one or more embodiments, the propylene-based elastomer is propylene/alpha-olefin copolymer with semi-crystalline isotactic propylene segments. The alpha-olefin content (e.g. polymerized ethylene content) may range from about 5 to about 18%, or in other embodiments from about 10 to about 15%.

In one or more embodiments, the propylene-based elastomer is characterized by a melting point that is less than 110° C. and a heat of fusion of less than 75 J/g. In one embodiment, the propylene based elastomers of the present invention have a glass transition temperature (Tg) range of about −25 to −35° C. The Tg as used herein is the temperature above which a polymer becomes soft and pliable, and below which it becomes hard and glassy. The propylene based plastomers and elastomers of the present invention have a MFR range measured at 230° C. of between about 0.5 to about 25, and a melt temperature range of about 50 to 120° C. In one embodiment, the propylene based elastomers of the present invention have a shore A hardness range of about 60 to about 90.

In one or more embodiments, the propylene-based elastomer is blended with a propylene-based thermoplastic resin, which may include a crystalline resin. In particular embodiments, the propylene-based thermoplastic resin is characterized by a melting point that is greater than 110° C. and a heat of fusion greater than 75 J/g. In one or more embodiments, the propylene-based thermoplastic resin is stereoregular polypropylene. In one or more embodiments, the ratio of the propylene-based elastomer to the propylene-based thermoplastic resin within the blend composition may vary in the range of 1:99 to 95:5 by weight and, in particular, in the range 2:98 to 70:30 by weight.

In one embodiment, the propylene-based elastomers may have a flexural modulus range of about 500 to about 6000 psi, preferably about 1500-5000 psi.

### Functionalized Thermoplastic Resin

As suggested above, one or more layers of the membranes of the present invention may include a functionalized thermoplastic resin. In one or more embodiments, the functionalized polymer is a thermoplastic polymer that includes at least one functional group. The functional group, which may also be referred to as a functional substituent or functional moiety, includes a hetero atom. In one or more embodiments, the functional group includes a polar group. Examples of polar groups include hydroxy, carbonyl, ether, ester halide, amine, imine, nitrile, oxirane (e.g., epoxy ring) or isocyanate groups. Exemplary groups containing a carbonyl moiety include carboxylic acid, anhydride, ketone, acid halide, ester, amide, or imide groups, and derivatives thereof. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof. In one or more embodiments, the functional group is pendant to the backbone of the hydrocarbon polymer. In these or other embodiments, the functional group may include an ester group. In specific embodiments, the ester group is a glycidyl group, which is an ester of glycidol and a carboxylic acid. A specific example is a glycidyl methacrylate group.

In one or more embodiments, the functionalized thermoplastic polymer may be prepared by grafting a graft monomer to a thermoplastic polymer. The process of grafting may include combining, contacting, or reacting a thermoplastic polymer with a graft monomer. These functionalized thermoplastic polymers include those described in U.S. Pat. Nos. 4,957,968, 5624,999, and 6,503,984, which are incorporated herein by reference.

The thermoplastic polymer that can be grafted with the graft monomer may include solid, generally high molecular weight plastic materials. These plastics include crystalline and semi-crystalline polymers. In one or more embodiments, these thermoplastic polymers may be characterized by a crystallinity of at least 20%, in other embodiments at least 25%, and in other embodiments at least 30%. Crystallinity may be determined by dividing the heat of fusion of a sample by the heat of fusion of a 100% crystalline polymer, which is assumed to be 209 joules/gram for polypropylene or 350 joules/gram for polyethylene. Heat of fusion can be determined by differential scanning calorimetry. In these or other embodiments, the thermoplastic polymers to be functionalized may be characterized by having a heat of fusion of at least 40 J/g, in other embodiments in excess of 50 J/g, in other embodiments in excess of 75 J/g, in other embodiments in excess of 95 J/g, and in other embodiments in excess of 100 J/g.

In one or more embodiments, the thermoplastic polymers, prior to grafting, may be characterized by a weight average molecular weight (M_{w}) of from about 100 kg/mole to about 2,000 kg/mole, and in other embodiments from about 300 kg/mole to about 600 kg/mole. They may also characterized by a number-average molecular weight (Mₙ) of about 80 kg/mole to about 800 kg/mole, and in other embodiments about 90 kg/mole to about 200 kg/mole. Molecular weight may be determined by size exclusion chromatography (SEC) by using a Waters 150 gel permeation chromatograph equipped with the differential refractive index detector and calibrated using polystyrene standards.

In one or more embodiments, these thermoplastic polymer, prior to grafting, may be characterized by a melt flow of from about 0.3 to about 2,000 dg/min, in other embodiments from about 0.5 to about 1,000 dg/min, and in other embodiments from about 1 to about 1,000 dg/min, per ASTM D-1238 at 230° C. and 2.16 kg load.

In one or more embodiments, these thermoplastic resins, prior to grafting, may have a melt temperature (Tₘ) that is from about 110° C. to about 250° C., in other embodiments from about 120 to about 170° C., and in other embodiments from about 130° C. to about 165° C. In one or more embodiments, they may have a crystallization temperature (T_{c}) of these optionally at least about 75° C., in other embodiments at least about 95° C., in other embodiments at least about 100° C., and in other embodiments at least 105° C., with one embodiment ranging from 105° to 115° C.

Exemplary thermoplastic polymers that may be grafted include polyolefins, polyolefin copolymers, and non-olefin thermoplastic polymers. Polyolefins may include those thermoplastic polymers that are formed by polymerizing ethylene or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene and ethylene and/or propylene with another α-olefin such as 1-butene, 1-hexene, 1-octene, 2-methyl-1-propene, 3-methyl-l-pentene, 4-methyl-l-pentene, 5-methyl-1-hexene or mixtures thereof is also contemplated. Other polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic polymers may include polymers and copolymers of styrene, α,β-unsaturated acids, α,β-unsaturated esters, and mixtures thereof. For example, polystyrene, polyacrylate, and polymethacrylate may be functionalized.

These homopolymers and copolymers may be synthesized by using an appropriate polymerization technique known in the art. These techniques may include conventional Ziegler-Natta, type polymerizations, catalysis employing single-site organometallic catalysts including, but not limited to, metallocene catalysts, and high-pressure free radical polymerizations.

The degree of functionalization of the functionalized thermoplastic polymer may be recited in terms of the weight percent of the pendent functional moiety based on the total weight of the functionalized polymer. In one or more embodiments, the functionalized thermoplastic polymer may include at least 0.2% by weight, in other embodiments at least 0.4% by weight, in other embodiments at least 0.6% by weight, and in other embodiments at least 1.0 weight percent functionalization, in these or other embodiments, the functionalized thermoplastic polymers may include less than 10% by weight, in other embodiments less than 5% by weight, in other embodiments less than 3% by weight, and in other embodiments less than 2% by weight functionalization.

In one or more embodiments, where the functionalized thermoplastic polymer is a functionalized propylene-based polymer, it can be characterized by a melt flow rate of from about 20 to about 2,000 dg/min, in other embodiments from about 100 to about 1,500 dg/min, and in other embodiments from about 150 to about 750 dg/min, per ASTM D-1238 at 230° C. and 2.16 kg load. In one or more embodiments, where the functionalized thermoplastic polymer is a functionalized ethylene-based polymer, it can be characterized by a melt flow index of from about 0.2 to about 2,000 dg/min, in other embodiments from about 1 to about 1,000 dg/min, and in other embodiments from about 5 to about 100 dg/min, per ASTM D-1238 at 190° C. and 2.16 kg load.

Functionalized thermoplastic polymers are commercially available. For example, maleated propylene-based polymers may be obtained under the tradename FUSABOND™ (DuPont), POLYBOND™ (Crompton), and EXXELOR™ (ExxonMobil). Another examples includes polymers or oligomers including one or more glycidyl methacrylate groups such as Lotader™ AX8950 (Arkema).

### Mineral Filler

In one or more embodiments, the fillers, which may also be referred to as mineral fillers, include inorganic materials that may aid in reinforcement, heat aging resistance, green strength performance, and/or flame resistance. In other embodiments, these materials are generally inert with respect to the composition therefore simply act as diluent to the polymeric constituents. In one or more embodiments, mineral fillers include clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof. In one or more embodiments, the fillers are not surface modified or surface functionalized.

Suitable clays may include airfloated clays, water-washed clays, calcined clays, surface-treated clays, chemically-modified clays, and mixtures thereof.

Suitable silicates may include synthetic amorphous calcium silicates, precipitated, amorphous sodium aluminosilicates, and mixtures thereof.

Suitable silica (silicon dioxide) may include wet-processed, hydrated silicas, crystalline silicas, and amorphous silicas (noncrystalline).

In one or more embodiments, the mineral fillers are characterized by an average particle size of at least 1 μm, in other embodiments at least 2 μm, in other embodiments at least 3 μm, in other embodiments at least 4 μm, and in other embodiments at least 5 μm. In these or other embodiments, the mineral fillers are characterized by an average particle size of less than 15 μm, in other embodiments less than 12 μm, in other embodiments less than 10 μm, and in other embodiments less than 8 μm. In these or other embodiments, the mineral filler has an average particle size of between 1 and 15 μm, in other embodiments between 3 and 12 μm, and in other embodiments between 6 and 10 μm.

### Other Ingredients

The thermoplastic membranes of the present invention (e.g., one or more layers of the membranes) may also include other ingredients such as those that are convention in thermoplastic membranes. For example, other useful additives or constituents may include flame retardants, stabilizers, pigments, and fillers.

In one or more embodiments, useful flame retardants include and compound that will increase the burn resistivity, particularly flame spread such as tested by UL 94 and/or UL 790, of the laminates of the present invention. Useful flame retardants include those that operate by forming a char-layer across the surface of a specimen when exposed to a flame. Other flame retardants include those that operate by releasing water upon thermal decomposition of the flame retardant compound. Useful flame retardants may also be categorized as halogenated flame retardants or non-halogenated flame retardants.

Exemplary non-halogenated flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), which is sold together as a polyol masterbatch, melamine polyphosphate is available under the tradename Budit™ 3141 (Budenheim), and antimony oxide (Sb₂O₃) is commercially available under the tradename Fireshield™. Those flame retardants from the foregoing list that are believed to operate by forming a char layer include ammonium polyphosphate and melamine polyphosphate.

In one or more embodiments, treated or functionalized magnesium hydroxide may be employed. For example, magnesium oxide treated with or reacted with a carboxylic acid or anhydride may be employed. In one embodiment, the magnesium hydroxide may be treated or reacted with stearic acid. In other embodiments, the magnesium hydroxide may be treated with or reacted with certain silicon-containing compounds. The silicon-containing compounds may include silanes, polysiloxanes including silane reactive groups. In other embodiments, the magnesium hydroxide may be treated with maleic anhydride. Treated magnesium hydroxide is commercially available. For example, Zerogen™ 50.

Examples of halogenated flame retardants may include halogenated organic species or hydrocarbons such as hexabromocyclododecane or N,N′-ethylene-bis-(tetrabromophthalimide). Hexabromocyclododecane is commercially available under the tradename CD-75P™ (ChemTura). N,N′-ethylene-bis-(tetrabromophthalimide) is commercially available under the tradename Saytex™ BT-93 (Albemarle).

In one or more embodiments, the use of char-forming flame retardants (e.g. ammonium polyphosphate and melamine polyphosphate) has unexpectedly shown advantageous results when used in conjunction with nanoclay within the cap layer of the laminates of the present invention. It is believed that there may be a synergistic effect when these compounds are present in the cap layer. As a result, the cap layer of the laminates of the certain embodiments of the present invention are devoid of or substantially devoid of halogenated flame retardants and/or flame retardants that release water upon thermal decomposition. Substantially devoid referring to that amount or less that does not have an appreciable impact on the laminates, the cap layer, and/or the burn resistivity of the laminates.

In one or more embodiments, the membranes of the invention may include a stabilizers. Stabilizers may include one or more of a UV stabilizer, an antioxidant, and an antiozonant. UV stabilizers include Tinuvin™ 622. Antioxidants include Irganox™ 1010.

In one or more embodiments, one or more layers of the membranes of the present invention may include expandable graphite, which may also be referred to as expandable flake graphite, intumescent flake graphite, or expandable flake. Generally, expandable graphite includes intercalated graphite in which an intercallant material is included between the graphite layers of graphite crystal or particle. Examples of intercallant materials include halogens, alkali metals, sulfates, nitrates, various organic acids, aluminum chlorides, ferric chlorides, other metal halides, arsenic sulfides, and thallium sulfides. In certain embodiments of the present invention, the expandable graphite includes non-halogenated intercallant materials. In certain embodiments, the expandable graphite includes sulfate intercallants, also referred to as graphite bisulfate. As is known in the art, bisulfate intercalation is achieved by treating highly crystalline natural flake graphite with a mixture of sulfuric acid and other oxidizing agents which act to catalyze the sulfate intercalation. Expandable graphite useful in the applications of the present invention are generally known as described in International Publ. No. WO/2014/078760, which is incorporated herein by reference.

Commercially available examples of expandable graphite include HPMS Expandable Graphite (HP Materials Solutions, Inc., Woodland Hills, Calif.) and Expandable Graphite Grades 1721 (Asbury Carbons, Asbury, N.J.). Other commercial grades contemplated as useful in the present invention include 1722, 3393, 3577, 3626, and 1722HT (Asbury Carbons, Asbury, N.J.).

In one or more embodiments, the expandable graphite may be characterized as having a mean or average size in the range from about 30 μm to about 1.5 mm, in other embodiments from about 50 μm to about 1.0 mm, and in other embodiments from about 180 to about 850 μm. In certain embodiments, the expandable graphite may be characterized as having a mean or average size of at least 30 μm, in other embodiments at least 44 μm, in other embodiments at least 180 μm, and in other embodiments at least 300 μm. In one or more embodiments, expandable graphite may be characterized as having a mean or average size of at most 1.5 mm, in other embodiments at most 1.0 mm, in other embodiments at most 850 μm, in other embodiments at most 600 μm, in yet other embodiments at most 500 μm, and in still other embodiments at most 400 μm. Useful expandable graphite includes Graphite Grade #1721 (Asbury Carbons), which has a nominal size of greater than 300 μm.

In one or more embodiments of the present invention, the expandable graphite may be characterized as having a nominal particle size of 20×50 (US sieve). US sieve 20 has an opening equivalent to 0.841 mm and US sieve 50 has an opening equivalent to 0.297 mm. Therefore, a nominal particle size of 20×50 indicates the graphite particles are at least 0.297 mm and at most 0.841 mm.

In one or more embodiments, the expandable graphite may be characterized by an onset temperature ranging from about 100° C. to about 250° C.; in other embodiments from about 160° C. to about 225° C.; and in other embodiments from about 180° C. to about 200° C. In one or more embodiments, the expandable graphite may be characterized by an onset temperature of at least 100° C., in other embodiments at least 130° C., in other embodiments at least 160° C., and in other embodiments at least 180° C. In one or more embodiments, the expandable graphite may be characterized by an onset temperature of at most 250° C., in other embodiments at most 225° C., and in other embodiments at most 200° C. Onset temperature may also be interchangeably referred to as expansion temperature; and may also be referred to as the temperature at which expansion of the graphite starts.

In one or more embodiments, one or more layers of the membranes of the present invention include a nanoclay. Nanoclays include the smectite clays, which may also be referred to as layered silicate minerals. Useful clays are generally known as described in U.S. Pat. No. 6,414,070 and U.S. Pat. Publ. No. 2009/0269565, which are incorporated herein by reference. In one or more embodiments, these clays include exchangeable cations that can be treated with organic swelling agents such as organic ammonium ions, to intercalate the organic molecules between adjacent planar silicate layers, thereby substantially increasing the interlayer spacing. The expansion of the interlayer distance of the layered silicate can facilitate the intercalation of the clay with other materials. The interlayer spacing of the silicates can be further increased by formation of the polymerized monomer chains between the silicate layers. The intercalated silicate platelets act as a nanoscale (sub-micron size) filler for the polymer.

Intercalation of the silicate layers in the clay can take place either by cation exchange or by absorption. For intercalation by absorption, dipolar functional organic molecules such as nitrile, carboxylic acid, hydroxy, and pyrrolidone groups are desirably present on the clay surface. Intercalation by absorption can take place when either acid or non-acid clays are used as the starting material. Cation exchange can take place if an ionic clay containing ions such as, for example, Na+, K+, Ca++, Ba++, and Li+ is used. Ionic clays can also absorb dipolar organic molecules.

Smectite clays include, for example, montmorillonite, saponite, beidellite, hectorite, and stevensite. In one or more embodiments, the space between silicate layers may be from about 15 to about 40 X, and in other embodiments from about 17 to about 36 X, as measured by small angle X-ray scattering. Typically, a clay with exchangeable cations such as sodium, calcium and lithium ions may be used. Montmorillonite in the sodium exchanged form is employed in one or more embodiments

Organic swelling agents that can be used to treat the clay include quaternary ammonium compound, excluding pyridinium ion, such as, for example, poly(propylene glycol)bis(2-aminopropyl ether), poly(vinylpyrrolidone), dodecylamine hydrochloride, octadecylamine hydrochloride, and dodecylpyrrolidone. These treated clays are commercially available. One or more of these swelling agents can be used.

### Amounts

In one or more embodiments, the ethylene-based olefinic block copolymer may form the entire thermoplastic component of the given layer in which the ethylene-based olefinic block copolymer is present. As suggested above, in other embodiments, the ethylene-based olefinic block copolymer is present in conjunction with a distinct and/or complementary thermoplastic polymer within the given layer in which the ethylene-based olefinic block copolymer is present.

In one or more embodiments, the layer in which the ethylene-based olefinic block copolymer is present includes at least 10, in other embodiments at least 40, and in other embodiments at least 60% by weight ethylene-based olefinic block copolymer based upon the total weight of the ethylene-based olefinic block copolymer and any complementary thermoplastic material. In these or other embodiments, the layer in which the ethylene-based olefinic block copolymer is present includes at most 100, in other embodiments at most 80, and in other embodiments at most 40% by weight ethylene-based olefinic block copolymer based upon the total weight of the ethylene-based olefinic block copolymer and any complementary thermoplastic material. In one or more embodiments, the layer in which the ethylene-based olefinic block copolymer is present includes from about 10 to about 100, in other embodiments from about 20 to about 90, and in other embodiments from about 50 to about 80% by weight ethylene-based olefinic block copolymer based upon the total weight of the ethylene-based olefinic block copolymer and any complementary thermoplastic material.

In one or more embodiments, the layer in which the ethylene-based olefinic block copolymer is present also includes a low density polyethylene (e.g. linear low density polyethylene), and in these embodiments, the layer may include at least 5, in other embodiments at least 20, and in other embodiments at least 40% by weight low density polyethylene based upon the total weight of the thermoplastic component of the layer. In these or other embodiments, the layer in which the ethylene-based olefinic block copolymer is present also includes a low density polyethylene (e.g. linear low density polyethylene), and in these embodiments, the layer may include at most 100, in other embodiments at most 80, and in other embodiments at most 40% by weight low density polyethylene based upon the total weight of the thermoplastic component of the layer. In one or more embodiments, the layer in which the ethylene-based olefinic block copolymer is present also includes a low density polyethylene (e.g. linear low density polyethylene), and in these embodiments, the layer may include from about 10 to about 100, in other embodiments from about 20 to about 90, and in other embodiments from about 50 to about 80% by weight low density polyethylene based upon the total weight of the thermoplastic component of the layer.

In one or more embodiments, where the one or more layers including the ethylene-based olefinic block copolymer includes a first EBOC (e.g. low melt index) and a second EBOC (e.g. high melt index), these one or more layers may include at least 40, in other embodiments at least 50, and in other embodiments at least 60 weight % of the first EBOC based upon the total weight of the first EBOC and the second EBOC combined. In these or other embodiments, these layers may include at most 99, in other embodiments at most 90, and in other embodiments at most 80 weight % of the first EBOC based upon the total weight of the first EBOC and the second EBOC combined. In one or more embodiments, these layers may include from about 30 to about 99, in other embodiments from about 50 to about 90, and in other embodiments from about 60 to about 80 weight % of the first EBOC based upon the total weight of the first EBOC and the second EBOC combined.

As discussed above, one or more layers of the membranes of the present invention include, along with ethylene-based olefin block copolymer, a relatively high loading of filler. As used herein, relatively high loading of filler refers to that amount or more of filler that would have an appreciable and deleterious impact on the membrane in the absence of the ethylene-based olefin block copolymer including, but not limited to, precluding the membrane from use in a mechanically-attached roofing system while meeting applicable industry standards. In one or more embodiments, the one or more layers of the membranes of the present invention that include the high loading of filler include at least 10 weight percent, in other embodiments at least 15 weight percent, in other embodiments at least 20 weight percent, in other embodiments at least 25 weight percent, in other embodiments at least 30 weight percent, in other embodiments at least 33 weight percent, in other embodiments at least 40 weight percent, and in other embodiments at least 45 weight percent of the filler (e.g. mineral filler) based on the entire weight of the given layer of the membrane that includes the filler. In one or more embodiments, the one or more layers of the membranes of the present invention that include the high loading of filler include at most 80 weight percent, in other embodiments at most 70 weight percent, and in other embodiments at most 60 weight percent of the filler based on the entire weight of the given layer of the membrane that includes the filler. In one or more embodiments, the one or more layers of the membranes of the present invention that include the high loading of filler include from about 33 to about 80, in other embodiments from about 40 to about 70, and in other embodiments from about 45 to about 60 weight percent of the filler based upon the entire weight of the given layer of the membrane that includes the filler.

In one or more specific embodiments, the membranes of the present invention are bilaminate membranes (optionally scrim-reinforced) that satisfy the requirements of ASTM 6878-03. The membranes of these embodiments include an upper layer (e.g., upper layer 14 in FIG. 1) that includes at least 15 weight %, in other embodiments at least 25 weight %, in other embodiments at least 30 weight %, and in other embodiments at least 35 weight % magnesium hydroxide. Additionally, the membranes of these embodiments include a lower layer (e.g., lower layer 12 of FIG. 1 opposite the scrim from layer 12) that includes at least 5 weight %, in other embodiments at least 10 weight %, in other embodiments at least 15 weight %, in other embodiments at least 20 weight %, in other embodiments at least 25 weight %, and in other embodiments at least 30 weight % mineral filler, and also includes the ethylene-based olefinic block copolymer according to embodiments of the invention. In particular embodiments, the lower layer (e.g., layer 12) includes mineral filler other than magnesium hydroxide (e.g., calcium carbonate). In particular embodiments, the lower layer (e.g., layer 12) includes magnesium hydroxide in combination with another mineral filler such as calcium carbonate.

In yet other embodiments, bilaminate membranes (optionally scrim-reinforced) satisfying the requirements of ASTM 6878-03 are prepared and include a coextruded upper layer that includes at least two coextruded layers as shown in FIGS. 1 and 2 (e.g., coextruded layers 28 and 30). In these embodiments, uppermost coextruded layer 30 includes at least 15 weight %, in other embodiments at least 25 weight %, in other embodiments at least 30 weight %, and in other embodiments at least 35 weight % magnesium hydroxide. Additionally, upper middle layer 28, as well as lower layer 12 (which may include coextruded layers 24 and 26), includes at least 5 weight %, in other embodiments at least 10 weight %, in other embodiments at least 15 weight %, in other embodiments at least 20 weight %, in other embodiments at least 25 weight %, and in other embodiments at least 30 weight % mineral filler, and also includes the ethylene-based olefinic block copolymer according to embodiments of the invention. In one or more embodiments, uppermost coextruded layer 30 includes ethylene-based olefinic block copolymer. In other embodiments, uppermost coextruded layer 30 is devoid or substantially devoid of ethylene-based olefinic block copolymer. In one or more embodiments, the mineral filler in lower layer 12 and upper middle layer 28 is a mineral filler other than calcium carbonate. In other embodiments, lower layer 12 and upper middle layer 28 include magnesium hydroxide in combination with another mineral filler such as calcium carbonate.

### Method of Making

In one or more embodiments, the compositions and membranes of the present invention may be prepared by employing conventional techniques. The polymeric composition that may be extruded to form the polymeric sheet may include the ingredients or constituents described herein. For example, the polymeric composition may include thermoplastic polyolefin, filler, and ethylene-based olefin block copolymers defined herein. The ingredients may be mixed together by employing conventional polymer mixing equipment and techniques. In one or more embodiments, an extruder may be employed to mix the ingredients. For example, single-screw or twin-screw extruders may be employed. For example, the various ingredients can be separately fed into a reaction extruder and pelletized or directly extruded into membrane or laminate sheet. In other embodiments, the various ingredients can be combined and mixed within a mixing apparatus such as an internal mixer and then subsequently fabricated into membrane sheets or laminates.

In one or more embodiments, the membranes of the present invention may be prepared by extruding a polymeric composition into a sheet. Multiple sheets may be extruded and joined to form a laminate. A membrane including a reinforcing layer may be prepared by extruding at least one sheet on and/or below a reinforcement (e.g., a scrim). In other embodiments, the polymeric layer may be prepared as separate sheets, and the sheets may then be calandered with the scrim sandwiched there between to form a laminate. In one or more embodiments, one or more layers of the membranes of the present invention are prepared by employing coextrusion technology. Useful techniques include those described in co-pending U.S. Ser. Nos. 11/708,898 and 11/708,903, which are incorporated herein by reference.

Following extrusion, and after optionally joining one or more polymeric layers, or optionally joining one or more polymeric layer together with a reinforcement, the membrane may be fabricated to a desired thickness. This may be accomplished by passing the membrane through a set of squeeze rolls positioned at a desired thickness. The membrane may then be allowed to cool and/or rolled for shipment and/or storage.

### INDUSTRIAL APPLICABILITY

The membranes of one or more embodiments of the present invention are useful in a number of applications. In one embodiment, the membranes may be useful for roofing membranes that are useful for covering flat or low-sloped roofs. In other embodiments, the membranes may be useful as geomembranes. Geomembranes include those membranes employed as pond liners, water dams, animal waste treatment liners, and pond covers.

As described above, the membranes of one or more embodiments of the present invention may be employed as roofing membranes. These membranes include thermoplastic roofing membranes including those that meet the specifications of ASTM D-6878-03. These membranes maybe employed to cover flat or low/sloped roofs. These roofs are generally known in the art as disclosed in U.S. Ser. Nos. 60/586,424 and 11/343,466, and International Application No. PCT/US2005/024232, which are incorporated herein by reference.

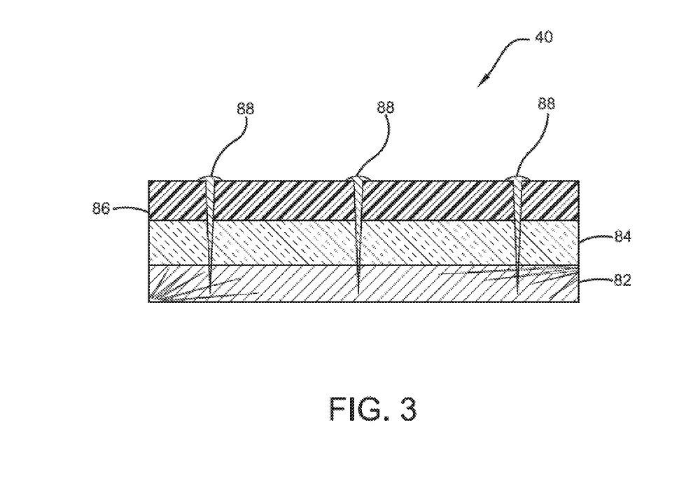

In one or more embodiments, the membranes of the present invention can advantageously be used to prepare mechanically-attached roofing systems. For example, as shown in FIG. 3, a mechanically-attached roofing system 40 include roof deck 82, optional insulation layer 84, thermoplastic membrane 86, which is in accordance with the present invention, and a plurality of fasteners 88.

Advantageously, the process can be used to construct a mechanically-attached roofing system meeting the standards of UL and Factory Mutual for wind uplift (e.g., FM 4470).

The substrate to which the membrane may be mechanically attached may include a roof deck, which may include steel, concrete, and/or wood. In these or other embodiments, the membranes may be applied over additional materials, such as insulation boards and cover boards. As those skilled in the art appreciate, insulation boards and cover boards may carry a variety of facer materials including, but not limited to, paper facers, fiberglass-reinforced paper facers, fiberglass facers, coated fiberglass facers, metal facers such as aluminum facers, and solid facers such as wood. In yet other embodiments, the membranes may be applied over existing membranes. These existing membranes may include cured rubber systems such as EPDM membranes, thermoplastic polymers systems such as TPO membranes, or asphalt-based systems such as modified asphalt membranes and/or built roof systems. Regardless of any intervening materials, the membrane may ultimately be mechanically attached to the roof deck using known techniques.

Practice of this invention is not limited by the selection of any particular roof deck. Accordingly, the roofing systems herein can include a variety of roof decks. Exemplary roof decks include concrete pads, steel decks, wood beams, and foamed concrete decks.

Practice of this invention is likewise not limited by the selection of any particular insulation board. Moreover, the insulation boards are optional. Several insulation materials can be employed including polyurethane or polyisocyanurate cellular materials. These boards are known as described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which is incorporated herein by reference.

In other embodiments, these membranes may be employed to cover flat or low-slope roofs following a re-roofing event. In one or more embodiments, the membranes may be employed for re-roofing as described in U.S. Publication No. 2006/0179749, which are incorporated herein by reference.

Various modifications and alterations that do not depart from the scope and spirit of this invention will become apparent to those skilled in the art. This invention is not to be duly limited to the illustrative embodiments set forth herein.

1. A thermoplastic roofing membrane comprising:
a planar thermoplastic sheet, optionally having more than one layer, where at least one layer of the membrane includes an ethylene-based olefinic block copolymer.

2. The roofing membrane of claim 1, where the membrane is a bilaminate membrane including upper and lower layers.

3. The roofing membrane of claim 1, where the lower layer includes the ethylene-based olefinic block copolymer and a filler.

4. The roofing membrane of claim 1, where the membrane is a multi-layered membrane including at least one pair of coextruded layers, where at least one of said pair of coextruded layers includes the ethylene-based olefinic block copolymer and a filler.

5. The roofing membrane of claim 1, where the layer including the ethylene-based olefinic block copolymer also includes linear low-density polyethylene.

6. The roofing membrane of claim 1, where the layer including the ethylene-based olefinic block copolymer also includes mineral filler.

7. The roofing membrane of claim 1, where the mineral filler is selected from the group consisting of clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof.

8. A mechanically-attached roofing system comprising:
i. a roof substrate;
ii. a thermoplastic membrane including at least one layer that includes an ethylene-based olefinic block copolymer; and
iii. fasteners that fasten the thermoplastic membrane to the roof substrate.

9. The roofing system of claim 8, where the roofing system includes a layer of insulation disposed between said roof substrate and said thermoplastic membrane.

10. The roofing system of claim 8, where the membrane is a bilaminate membrane including upper and lower layers.

11. The roofing system of claim 8, where the lower layer includes the ethylene-based olefinic block copolymer.

12. The roofing system of claim 8, where the membrane is a multi-layered membrane including at least one pair of coextruded layers, where at least one of said pair of coextruded layers includes the ethylene-based olefinic block copolymer.

13. The roofing system of claim 8, where the layer including the ethylene-based olefinic block copolymer also includes linear low-density polyethylene.

14. The roofing system of claim 8, where the propylene-based polymer is non-functionalized.

15. The roofing system of claim 8, where the filler is selected from the group consisting of clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof.

16. A method for forming a mechanically-attached roof system, the method comprising:
i. applying a membrane to a roof substrate, wherein the membrane includes a planar sheet of thermoplastic polymer, optionally having more than one layer, where at least one layer of the membrane includes an ethylene-based olefinic block copolymer and at least 10 percent by weight filler, based on the total weight of the at least one layer; and
ii. mechanically fastening the membrane to the substrate.
